(19) United States
(12) Patent Application Publication
(10) Pub. No.: US 2016/0299985 A1
(43) Pub. Date: Oct. 13, 2016

(54) Method for accessing last search

(71) Applicant: Eric Poindessault, Paris (FR)

(72) Inventor: Eric Poindessault, Paris (FR)

(21) Appl. No.: 14/545,260

(22) Filed: Apr. 13, 2015

(51) Int. Cl. G06F 17/30; H04L 29/08

(52) U.S. Cl. CPC G06F 17/30876; H04L 67/02; G06F 17/30312

(57) ABSTRACT

In accordance with the principles of the present invention, a computer implemented method for obtaining information is provided. A reference of a search query is created and stored locally in a memory of a browser or a browser extension. The reference of a last search query is designated automatically with a browser in communication with the memory. Without displaying it to a user, the browser renders the designated reference. The rendered designated reference is displayed on a display in communication with the browser upon an event, such that the user may quickly and directly access the last search query. This Abstract is submitted with the understanding that it will not be used to interpret or limit the scope or meaning of the claims.

### RELATED APPLICATION

This application claims the benefit of U.S. Provisional Patent Application Ser. No. 61/985,689, filed 29 Apr. 2014, entitled “Method for Accessing Last Search”, which is hereby incorporated by this reference in its entirety.

### FIELD OF THE INVENTION

The present invention relates to tools for browsing the Internet.

### BACKGROUND OF THE INVENTION

The Internet is a global network of computers. Web browsers can use this network to retrieve hypertext files from remote servers, and hyperlinks in those files can be used to link together webs of documents. User interfaces such as Graphical User Interfaces (GUI) are typically used to navigate the Internet to retrieve relevant documents. Uniform Resource Identifiers (URI) such as a Uniform Resource Locator (URL) are used to identify specific web sites and web pages on the Internet. URLs also identify the address of the document to be retrieved from a network server. The Transfer Control Protocol/Internet Protocol (TCP/IP) is used to transfer information.

Web browsers use a hypertext language referred to as the HyperText Mark-up Language (HTML). HTML is a commonly used markup language that permits content providers or developers to place hyperlinks within web pages. These hyperlinks link related content or data, which may be found on multiple Internet host computers. Web browsers may retrieve remote data by use of HyperText Transfer Protocol (HTTP). Alternatively, File Transfer Protocol (FTP) for file transfer, the Network News Transfer Protocol (NNTP) for discussion groups, and the Simple Mail Transport Protocol (SMTP) for email or other Internet application protocols can be used. When a user selects by, for example ‘clicking’ on a link in a web document, the link element in the document contains the URL that the client application employs to initiate the session with the server storing the linked document. HTTP is the protocol used to support the information transfer.

While most of today's users of the Internet believe it is a recent communications phenomenon, the origins of the Internet actually go back several decades. Today's Internet grew out of a computer resource-sharing network created in the 1960s by the Advanced Research Projects Agency (ARPA). This computer resource-sharing network, which came to be known as the ARPAnet, was primarily designed by ARPA's chief scientist, Larry Roberts. The initial problem facing a wide-area computer resource-sharing network was how to efficiently transmit digitized information in a reliable way. To solve this problem, in 1968, Roberts mandated use of a packet-switching design in the ARPAnet.

Packet switching breaks up blocks of digitized information into smaller pieces called packets. These packets are transmitted through the network, possibly by different routes, and are then reassembled at their destination. Eight years prior to ARPA's Request for Proposal, Len Kleinrock invented packet switching. See, e.g., Len Kleinrock, “Information Flow in Large Communications Nets,” RLE Quarterly Progress Report (1960); Len Kleinrock, Communication Nets (1964). See also Paul Baren, “On Distributed Communications Networks,” IEEE Transactions on Systems (March 1964). Roberts believed that packet switching was the means efficiently to transmit digitized information in a reliable way.

The next problem to solve was how to interconnect a number of mainframe computers, most of which utilized different languages and different operating systems. Wesley Clark of Washington University in St. Louis, Mo. devised the solution to this huge incompatibility problem. Clark proposed that a smaller microcomputer should interface between mainframes and the network. These minicomputers would run on the same operating system and use the same language. Each mainframe, therefore, would only be required to interface with its own minicomputer, with the minicomputer translating into the network operating system and language. These Interface Message Processors (IMP), which provided an interface between the ARPAnet host mainframe computers and the ARPAnet, were the predecessors to today's routers. With this basic design, the first two nodes on the ARPAnet communicated on 1 Oct. 1969.

By 1971, 15 nodes, mostly academic institutions, were up on the ARPAnet; however, the original goal of the ARPAnet was not being realized. Resource sharing of the mainframe computers was simply too cumbersome. In March 1972, Ray Tomlinson of consulting firm Bolt, Beranek & Newman invented e-mail. Use of this message transfer program quickly grew to be the initial major use of the ARPAnet.

By the mid-seventies, the ARPAnet was not the only network utilizing switching packets. Once again, an incompatibility problem emerged. Each of these different networks used a different protocol. Thus, interconnection of these different networks was not possible. The solution, devised by Robert Kahn of ARPA and Vincent Cerf of Stanford University, TCP/IP. The Transmission Control Protocol portion packetized information and reassembled the information upon arrival; the Internet Protocol portion routed packets by encasing the packets between networks. See, e.g., Robert Kahn and Vincent Cerf, “A Protocol for Packet Network Intercommunication,” IEEE Transactions on Communications Technology (May 1974). TCP/IP was adopted by the ARPAnet in 1983. With the addition of the Domain Name System (DNS) in November 1983, the now familiar Internet address protocol was established.

A next step occurred in 1990, when an Englishman, Tim Berners-Lee working at the European Center for Particle Research (CERN) in Switzerland, invented the World Wide Web. This software, based on a program Berners-Lee had written in 1980 to allow users to store information using random associations, allowed material from any computer, from any format to be translated into a common language of words, images, and addresses. Berners-Lee's program established the three core components of the World Wide Web: URL, HTTP, and HTML.

More recent innovations include: the founding in October 1994 by Tim Berners-Lee of the World Wide Web Consortium (W3C), an international community where member organizations, a full-time staff, and the public work together to develop Web standards; the introduction in December 1995 of the JavaScript species of ECMAScript, developed by Brendan Eich of Netscape, a prototype-based, object-oriented scripting language; the introduction on 26 Jan. 2000 by the W3C of the eXtensible HyperText Markup Language (XHTML), a family of XML markup languages that mirror or extend versions of the HTML; the development from 2000-2002 of the XMLHttpRequest, an Application Programming Interface (API) available in web browser scripting languages such as JavaScript used to send HTTP or HTTPS requests directly to a web server and load the server response data directly back into the script; the founding in 2004 of the Web Hypertext Application Technology Working Group (WHATWG), a community of people focusing on the development of HTML and APIs needed for Web applications; and the ongoing development of the latest revision of the HTML standard, HTML5.

Information on the World Wide Web is found through the use of search engines. When performing the task of searching the web for a specific resource in a web browser, users often desire quick access to their last page of search results in a tab to minimize overall task time; however, these users often lose track of that page due to activating multiple links. Re-entering the search query is undesirable because the user may forget the search query or lose track of which result pages have already been search.

Metrics often associated with efficient web search are “page load time”, “user interface latency”, and “task time”. Page load time is the time it takes a page to load, from initiation of the page view by activating a page link, through downloading of the hypertext file, to displaying a complete page. This page load time is dependent on a client's bandwidth and network latency. Thus, it would be desirable to minimize the user's experience of page load time.

User interface latency refers to the time consumed by an application between when the user makes an action (like a click or typing a letter), and the action triggering an event on the page. This user interface latency is dependent on whether the user interface must access a server or search through many resources before displaying a response. Thus, it would be desirable to minimize lag associated with user interface latency.

Task time is the total duration required for a user to complete a task. The task time for web browsing can be measured by averaging the time a group of users take to find a specific page on the web. This task time may be increased by lagging associated with interface latency and load times, but also includes the time required for a user to comprehend any supplemental tools loaded on a page. This time is a key metric for measuring efficiency of a user interface and directly correlates to the productivity of a user.

The problem users encounter while web browsing begins when a user selects a search result in a list of search results. The list of search results may be called the search query results page. Once the user is within a page displaying the content, the user navigates further away from the search query results page by further selecting multiple links. In order to get back to the search results page, the user must select the back button multiple times or browse through the web browsing history in a menu option.

Selecting the back button multiple times is an inefficient process because of the lag associated with interface latency or page load times. Furthermore, a user must quickly review each page before selecting the back button again. This greatly increases the overall task time. Therefore, it would be desirable to overcome the setbacks associated with selecting the back button multiple times.

Browsing through the web browser's history is an inefficient process because the user must discern between many pages and then reload the sought after page after that page has been found. While surfing the web, a user often selects at least four or five links in a minute's time. Because web browsing history is conglomerated in one area, finding a specific page within that web browsing data can be a daunting task. Additionally, this process can have an undesired load time because the browser must re-execute the search query and reload the page. Therefore, a need exists to assist web history navigation, while lowering the overall task times associated with the normal web browsing.

Various web browsing techniques have been proposed for lowering the task time associated with searching the web. For example, one approach involves opening multiple tabs and preloading pages that a user might wish to select in each tab; however, rendering multiple pages at a time uses significant resources of the client and is likely to decrease the overall user experience because this approach slows load times. Therefore, a need exists for a computer to automatically load only needed pages without expending significant resources.

Another approach involves saving all searches to a search history panel, and keeping this panel open at all times. There are many problems with this approach. First, the user is required to manually organize all of their search pages because search pages are organized by category. A second problem occurs when storing (or caching) multiple search pages. Caching every page a user views wastes client resources, which can slow down interface latency, load times, and overall task time. Therefore, a need exists for a computer to automatically choose only specific pages to cache without expending significant client resources.

Another approach is to have the user declare a query as important and have the computer periodically search that query and return results. Having the user declare which queries should be re-executed slows the overall task time of searching the web because the user is then required to focus on something other than the priority task. Having users do additional work is not desired, and a need still exists for a more automated approach. Additionally, the search query is re-executed every time a search query results page is loaded. Re-executing the same search query repeatedly causes a delay from page load times, which increases the overall task time.

Thus, a browser or browser extension that does not unduly waste client resources, but also does not prolong the steps necessary to quickly navigate the web in order to complete a search task would be desirable.

### SUMMARY OF THE INVENTION

The present invention helps minimize the user's experience of page load time. The present invention helps minimize lag associated with user interface latency. The present invention helps overcome the setbacks associated with selecting the back button multiple times. The present invention assists web history navigation, while lowering the overall task times associated with the normal web browsing. The present invention improves the loading of only needed pages without expending significant resources. The present invention helps to automatically choose only specific pages to cache without expending significant client resources. In utilizing the present invention, a browser or browser extension does not unduly waste client resources, but also does not prolong the steps necessary to quickly navigate the web in order to complete a search task.

In accordance with the principles of the present invention, a computer implemented method for obtaining information is provided. A reference of a search query is created and stored locally in a memory of a browser or browser extension. The reference of a last search query is designated automatically with a browser in communication with the memory. Without displaying it to a user, the browser renders the designated reference. The rendered designated reference is displayed on a display in communication with the browser upon an event, such that the user may quickly and directly access the last search query. This Abstract is submitted with the understanding that it will not be used to interpret or limit the scope or meaning of the claims.

This Summary introduces concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWING

FIG. 1 is a schematic diagram of an example system blueprint in accordance with an embodiment of the present invention.

FIG. 2 is a flow chart illustrating an example user flow in accordance with an embodiment of the present invention.

FIG. 3 is diagram illustrating an example state machine in accordance with an embodiment of the present invention

FIG. 4 is a flow chart illustrating an example storing process in accordance with an embodiment of the present invention.

FIG. 5 is a flow chart illustrating an example rendering process in accordance with an embodiment of the present invention.

FIG. 6 is a schematic diagram illustrating an example system blueprint for providing a browser extension in accordance with an embodiment of the present invention.

FIG. 7 is a schematic diagram illustrating an example process for providing an extension in accordance with an embodiment of the present invention.

FIG. 8A is a schematic template illustrating an example graphical user interface of a browser with an extension in accordance with an embodiment of the present invention.

FIG. 8B is a schematic template illustrating an example GUI of a browser with an extension after triggering an intermediate event in accordance with an embodiment of the present invention.

FIG. 9 is a schematic template illustrating an example display of a search query results window in accordance with an embodiment of the present invention.

FIG. 10A is a schematic template illustrating an example graphical user interface of a browser with an active tab in accordance with an embodiment of the present invention.

FIG. 10B is a schematic template illustrating an example graphical user interface of a browser with an active tab after triggering an intermediate event in accordance with an embodiment of the present invention.

FIG. 11 is a schematic template illustrating an example display of a search query results window for an active tab in accordance with an embodiment of the present invention.

FIG. 12A is a schematic template illustrating an example graphical user interface of a browser with a search results window for a first active tab in accordance with an embodiment of the present invention.

FIG. 12B is a schematic template illustrating an example graphical user interface of a browser with a search results window for a second active tab in accordance with an embodiment of the present invention.

### DETAILED DESCRIPTION OF A PREFERRED EMBODIMENT

While the present invention may be embodied in many different shapes, forms, sizes, colors, designs or configurations, for the purpose of promoting an understanding of the principles of the invention, reference will be made to the embodiments illustrated in the drawings and specific language will be used to describe the same. It will nevertheless be understood that no limitation of the scope of the invention is thereby intended. Any alterations and further implementations of the principle, the essence or the spirit of the invention as described herein are contemplated as would normally occur to one skilled in the art to which the invention relates.

A method for accessing last search in accordance with an embodiment of the present invention generally can reside in a browser or a browser extension that provides quick access to the last page of queried search results and minimizes consumption of client resources. A system for providing relevancy of content in accordance with an embodiment of the present invention assists users in lowering the task time associated with searching the web. Essentially, saving the last search query results page helps eliminate delay associated with load times when reviewing that page, and locally storing Document Object Models (DOMs) of only the most likely pages to be re-viewed helps conserve client resources.

A preferred embodiment of the present invention uses a computer, referred to as a client, to create a reference of a returned search query. The reference is created and stored locally on the client to eliminate lag associated with latency times and load times.

A preferred embodiment of the present invention automatically searches information in the browser for the last search query results page and designates that information to a reference. The client then renders the designated reference without necessarily displaying it on the user's screen. Once a user wants to jump back to the designated reference, he may effect an event. The event triggers the client to display the rendered page. In this manner, the user constantly has quick access the last returned search query page, but does not waste client resources by pre-rendering multiple pages that the user might try to view later.

An aspect of the present invention is directed to associating a reference to a last returned search query of an individual tab opened within a browser. Tabs within a browser have their own history of pages visited. An embodiment of the present invention directs the client to create an additional reference for tabs so tabs can be automatically searched for their last search query results page. This method of storing a last search query results page for tabs organizes searching more effectively than conglomerating search pages in one place. These simple and intuitive organization techniques help decrease the task time of web searching without creating a significant burden on client resources.

Another aspect of the present invention is directed to having an event that triggers a display of only the designated reference associated with the active tab. In this aspect of the invention, the triggering event has a listener for when the user switches tabs. The active tab determines which rendered page the triggering event will display.

Another aspect of the present invention is repeating the steps of designating and rendering a search query results page after each new search query is made. For example, a user may perform a search, which would cause an embodiment of the present invention to create a reference, designated the reference to the user's search, and render the search query results page; however, the user may not decide to display that particular search query results page. When the user performs another search in the same tab, rather than creating an additional reference, the client re-designates the existing reference to the new search, and renders the new search query results page. Only designating and rendering one page after a new search has been made, helps free up client resources making the process more efficient.

In an embodiment of the invention, a user's browsing within an individual tab does not affect the rendered designated reference for other tabs. In this embodiment, the rendered designated reference is changed when the user leaves a returned search query made within that tab that is different than the page that is already rendered.

Another aspect of the invention is directed towards a browser or browser extension that provides functionality to ‘leap back’ to the last search query results page while the user navigates through other pages. A browser extension is a computer program that extends the functionality of a web browser in some way. Browser extensions can change the user interface of the web browser without directly affecting viewable content of a web page; for example, by adding a ‘toolbar’. The browser or browser extension provides such functionality by identifying when a user makes a search query and locally storing the search query results page in a first variable. If the user selects by, for example, ‘clicking’ on a specific search result, then the browser or browser extension loads the last search query results page from the first variable into a second variable. This allows the user to jump back to their second to last search query results page, when they are currently on a search query results page. This functionality is desirable when users use similar but different search terms in two searches, and realize that previous search terms were better. The application of this embodiment also helps conserve client resources because a search query results page is not loaded until necessary.

Another aspect of the invention is providing access to the last search query results page through a quick and intuitive interface that does not clutter a user's work space. For example, the user can be provided access through a displayed widget. The widget can hang off the screen until the user pulls the widget onto the screen with for example a swiping motion or by placing a mouse near the widget. Once the widget is fully displayed, a user can access the rendered last search query results page by selecting the widget. Other embodiments can simply have the rendered page hanging off the screen, and the user can pull the page on to the screen for example by performing a mouse over event, a clicking event, a swiping event or a hot key event. Yet another example of accessing the rendered page includes two consecutive events: for example, a swipe and click or a pinch and turn. These events can be defined by any number of input devices such as a mouse, keyboard, touch pad, touch screen, a camera, a three dimensional camera, voice recognition software, a heat sensor, a light sensor, and the like, or any combination thereof.

Another aspect of the invention involves determining what information is stored to render the last search query results page. The information preferably includes the Uniform Resource Locator (URL) of the page as well as a DOM of the search query results page. The DOM has the search results in a list format similar to the format of the page after it had been initially queried. The information can also include metadata of the search terms used, the search engine used, the time the search was performed, the time since the search was performed, the number of results on the page, the number of results on the page that have been selected, a thumbnail of the page or even a link list to the last search query results page that was loaded when that query was performed. In this manner, a user can leap back through each search query results page associated with a tab.

Another aspect of the present invention involves determining where the information is stored. By storing information for the duration of a browsing session, a user's searching remains private, and this data is less likely to be exploited by other programs. Only storing session variables also helps conserve client resources. Furthermore, storing information locally instead of remotely helps prevent lag associated with load times and interface latency.

Another embodiment of the invention relates to providing a browser or browser extension for accessing the last returned query results for the active tab opened in a browser. In this embodiment, the browser or browser extension locally stores data associated with queried results by creating a new reference in response to leaving a search query results page. Thus, the creation step occurs not from opening a new tab, but from leaving a new search query results page.

Another aspect of the invention is defining what the browser or browser extension does if the user has not yet had a search query results page. For example, in one embodiment if the user tries to access the empty page, the browser or browser extension directs the user to a search engine page; in another embodiment, if the user tries to access an empty last search query results page, the browser or browser extension goes through the browser's internet history to find the last search query results page. Both of these embodiments help minimalize the task time associated with searching the web because both embodiments provide the user with additional intuitive functionality that does not significantly affect the overall performance of the client.

Another aspect of the invention relates to loading the browser extension onto the browser. In this process, when a web browser is launched the extension calls a remote service and compares the extensions version numbers. If the remote service has a more current version, then the extension downloads the most current version from the remote service and stores it locally. Then the extension grants the user functionality of leaping back to the most recent search query results page as heretofore described.

In more detail, a web browser is a software based user interface that allows users to find and read markup language documents available on the Internet and other networks. Typically, web browsers display a markup language document in a window with an address bar, a back button, a forward button, a refresh button, and a menu button that allows the user to access web browsing history. This web browsing history may be organized by date and time, but usually is not organized any further.

Additionally, most web browsers have ‘tabs’ that allow a user to have multiple markup language documents open in each window. The tabs have local data associated with the back and forward buttons of each tab. The tab currently displayed to the user is referred to as the active tab.

Session variables refer to variables that are associated with a browser. Session variables can be cleared after a length of time or from an event such as for example clearing the browser history. These session variables include, but are not limited to, variables connected to pages such as COOKIES, SESSION, GET, REQUEST, POST, and similar variables and functionalities. Session variables are distinguished from persistent variables, which remain stored even when a browser is cleared. Locally storing a session variable refers to temporarily storing the session variable on the client rather than a remote server.

A reference points to a specific type of data or set of specific types data, and includes, but is not limited to, references such as pointers, variables, links, files or simply a specific area in the client's memory. Specific types of data include, but are not limited to, booleans, integers, floats, doubles, characters, strings, URLs, DOMs, file types, arrays, and objects. A reference may access specific types of data or a data set through data structures such as link lists.

Web navigation refers to the process of navigating a network of information resources on the World Wide Web, which is organized as a hypertext or hypermedia. While web navigation is assisted by the back button, the forward button, and accessing the browsing history, the main method of web navigation is the process of selecting hyperlinks (or simply links) to display other hypertext documents. A hyperlink is a reference in a hypertext document to another hypertext document. Hyperlinks include, but are not limited to, buttons, form actions such as pressing enter, thumbnails, and images.

Search engines provide an additional tool for web navigation by taking in a search query and comparing the inquiry with other data to provide a search query results page. A search query results page is a list of multiple links returned from a search query. A search query results page is distinguished from a result page, which is a page that displays the content of a single result. While early search query results pages were merely a list of URLs, modern day search engines provide lists of more user friendly data. This includes, but is not limited to, titles of the documents, images, thumbnails, descriptions of a page, excerpts from a page, lists of links within a page, links to similar pages, and advertisements.

Many methods exist for searching through multiple web pages, with such methods usually involving returning to a former search query results page. By eliminating delay associated with this requirement, the overall search task time can be reduced. Furthermore, a search strategy organized with this functionality in mind allows the user to be more productive.

An example of an unproductive search strategy involves opening a different tab for each link, and leaving a search results page open in a different tab or window. A user then peruses the content and selects further content until finding a needed result or discovering new search terms. This method is disorganized because there is no connection between the queried search results and the content being searched. Under this method, a user cannot efficiently run multiple search queries and review multiple search results because there is no association between the tabs that contain content and the tabs that have search result links that lead to content. Furthermore, the client can no longer use the back button to get back to navigate to the original search query results page because the content was opened in a different tab.

More organized search strategies involve breadth first searching or depth first searching. In these methodologies, a user mechanically opens each page (or node) in a search tree, until all possible nodes are exhausted. A breadth first search involves doing a cursory analysis of a set of the links among the search results, and then opening the content of every page in the set, and doing another cursory scan of set of links before opening the next set; however, displaying multiple pages at a time uses significant resources of the client, and likely decreases the overall effectiveness of a search because of slow load times.

A depth first search involves drilling down to the most likely sought after node by selecting links until that branch of nodes is exhausted; then going up one node (in this case, by selecting the back button), and drilling down again in a methodical manner until each node has been searched. When that sub-branch of nodes is exhausted, a user selects the back button twice to check the next branch. This method of searching is time consuming because every node must be searched before a user can move on to the next search result on a search results page. Often users obtain enough information about a particular website after drilling down to the lowest node one time, and then the user leaps back to the original search query results page.

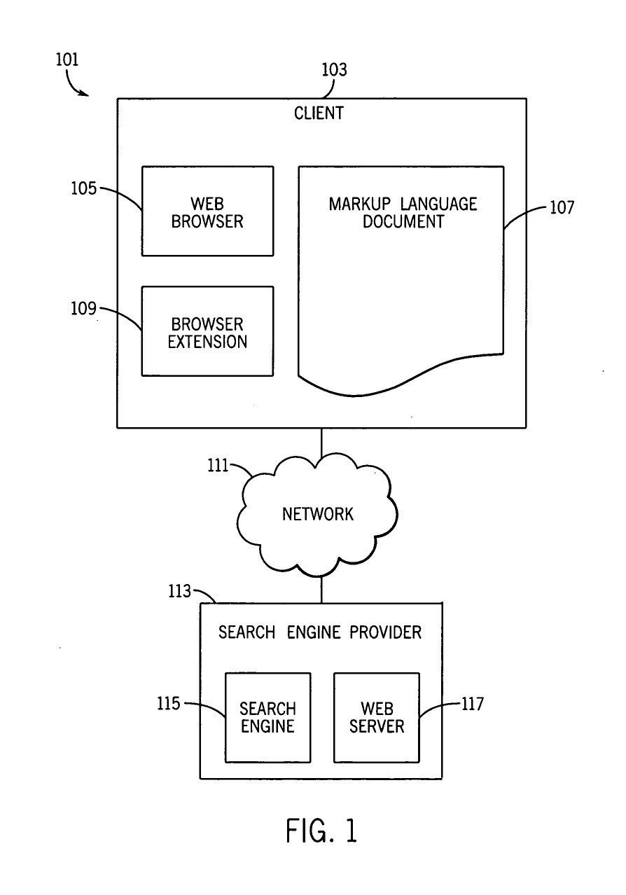

Referring to FIG. 1, a schematic diagram of an example system blueprint according to an embodiment of the present invention is seen. The system 101 can include a client 103, a network 111, and a search engine provider 113. The search engine provider 113 can include a remote web server 117 and a search engine 115. The client 103 accesses the search engine provider 113 through the network 111. The client can include a web browser 105, a browser extension 107, and a markup language document 109.

The web browser 105 displays a markup language document 107. Additionally, the web browser 105 has ‘tabs’ that allow a user to have multiple markup language documents open in each window. The tabs have local data associated with the back and forward buttons of each tab. A browser extension 109 is added on to the browser to access data associated with the browser, such as specific tab data, and provides additional functionality to the user.

The browser extension 109 in this embodiment provides additional functionality to the user when a search engine 115 provides the client 103 with a particular type of markup language document 107 called a search query results page. A search query results page can be cached in the web server 117, but does not originate from the search engine provider 113.

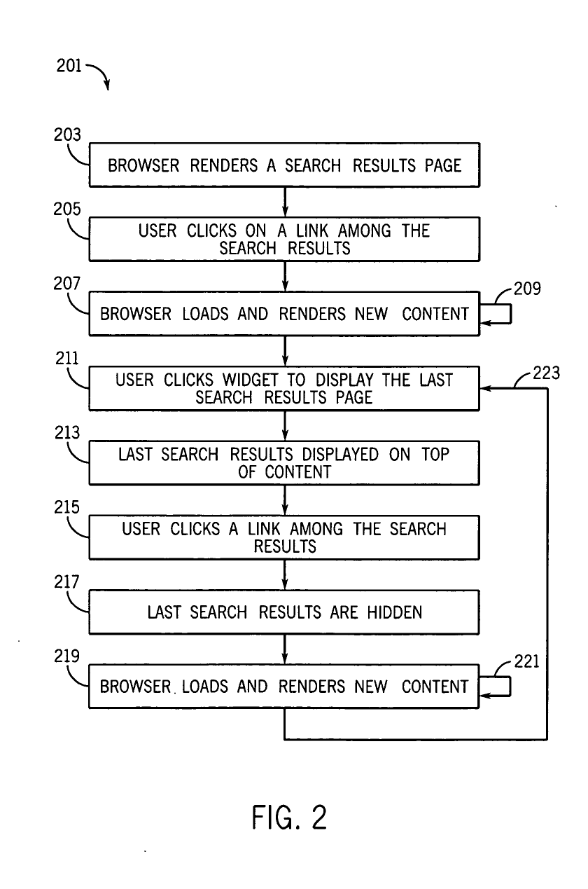

FIG. 2 is a flow chart illustrating an example user flow when a user seeks access to a second search result after drilling down through a first search result according to an embodiment of the present invention. Providing access to the last search query results page in this manner 201 helps eliminate delay associated with load times. The process 201 starts when the browser renders a search query results page 203. The user can choose a link 205 among the search results, and the browser loads and renders the content from that link 207. The content often has additional links, so the user can select other links 209 among these content pages, wherein the browser will load and render this new content 207.

When the useful content of that search result is exhausted, the user can select a widget to display the last search query results page 211. Then the last search query results page is displayed on top of the current content page 213. The user can then select a link among the search query results page 215, and the last search query results page is hidden 217, so the browser can load and render the new content 219. Again, the new content often has additional links, so the user can select other links 221 among these content pages, wherein the browser will load and render this new content 219. Once the useful content of this new content is exhausted, the user can loop back 223, and select the widget to display the last search query results page 211. Once enough content resources are exhausted, the user may decide to enter a new search query. If the browser renders a new search query results page, then the entire process 201 can start over.

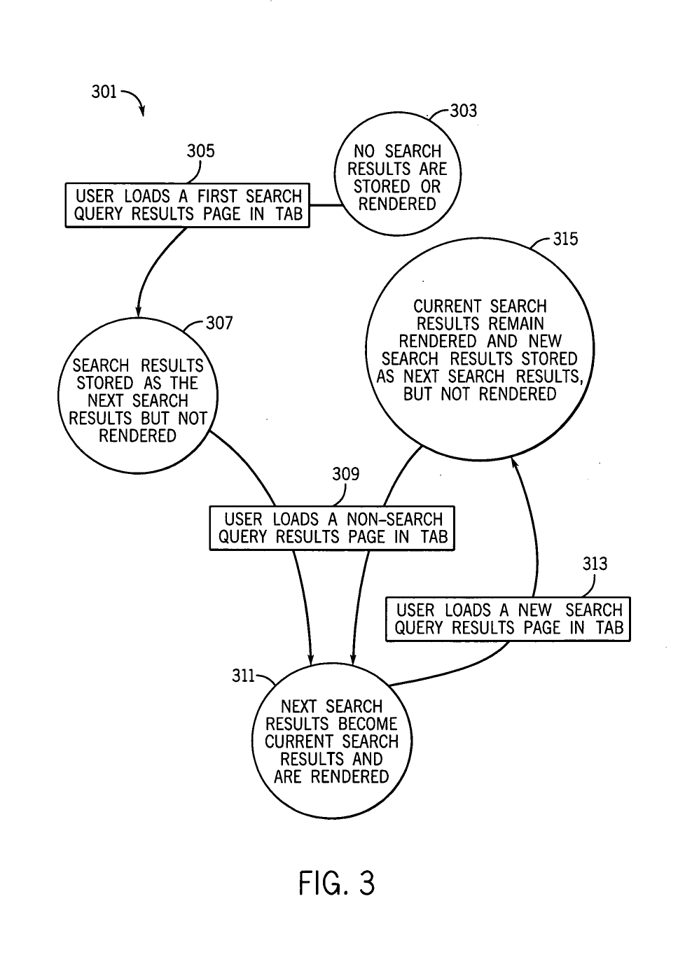

FIG. 3 is a diagram illustrating an example state machine in an embodiment of the present invention. The state machine 301 has a first reference to a CURRENT search query results page and a second reference to a NEXT search query results page. The state machine 301 renders a page associated with one of these references based on the state of the state machine. The states of the state machine require no particular order, but are numbered from first through fourth to promote understanding of the invention.

In the first state 305, references are not stored and search query results pages are not rendered. This first state 305 may be entered when a user starts a browsing session in a new tab or when all references are cleared. The state machine 301 is not necessarily in the first state 305 when the browser is opened because the browser may retain session variables from a previous session or data can be loaded into the references from the browser history, depending on the embodiment of the invention.

When a user loads a first search query results page in a tab, the state machine 301 transitions 307 from the first state 305 to the second state 309. In the second state 309, a reference to the first search query results page is stored in the NEXT reference, but not rendered. The state machine 301 transitions 311 from the second state 309 to the third state 313 when a user loads a non-search query results page in the tab. In the third state 313, the information in the NEXT reference is stored in the CURRENT reference, and the state machine 301 takes the information from the CURRENT reference to render a page. In this particular example, the CURRENT reference is to the first search query results page, so the first search query results page is rendered.

When a user loads a new search query results page in the tab, the state machine 301 transitions 315 from the third state 313 to the fourth state 317. In the fourth state 317, the page associated with the CURRENT reference remains rendered, and a reference to the new search query results page is store in the NEXT reference, but not rendered. In this particular example, the new search query results page would be referred to as the second search query results page. The first search query results page remains rendered and references by the CURRENT reference, but the second search query results page is now referenced by the NEXT reference.

When a user loads a non-search query results page in the tab, the state machine 301 transitions 311 from the fourth state 317 to the third state 313. In the third state 313, the information in the NEXT reference is stored in the CURRENT reference, and the state machine 301 takes the information from the CURRENT reference to render a page. In this particular example, the CURRENT reference is to the second search query results page, so the second search query results page is rendered. If a new search query results page were to be loaded in the tab, it would be the third search query results page in this example, and the state machine 301 would transition 315 to the fourth state 317.

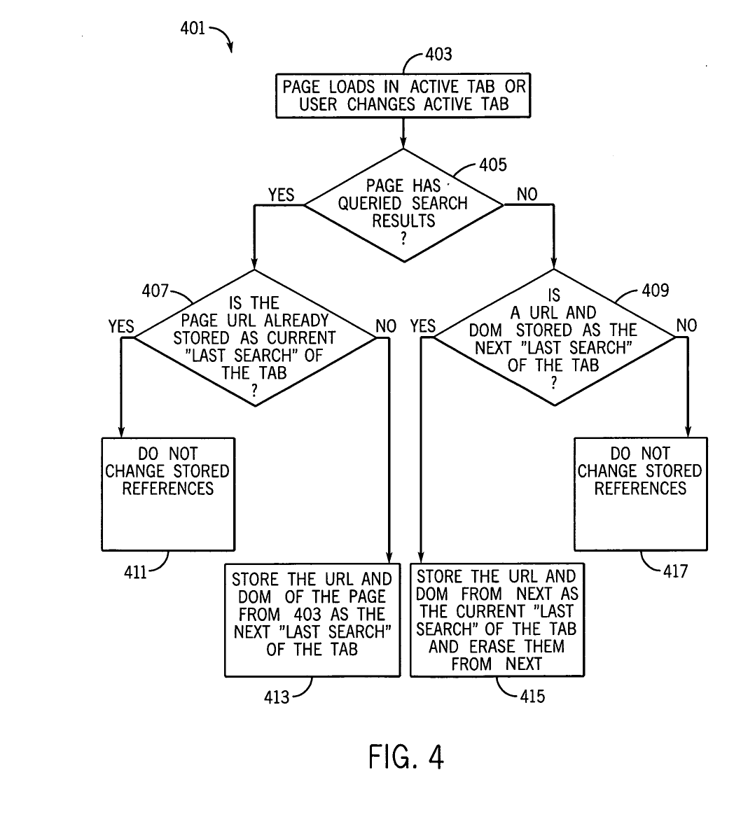

FIG. 4 is a flow chart illustrating an example storing process according an embodiment of the present invention. Locally storing document object models in this manner 401 helps conserve client resources. The storing process 401 can start from one of two triggering events 403: the first triggering event is if a page loads in an active tab; the second triggering event is if a user changes the active tab.

Once one of these triggering events occurs 403, the next step 405 is determining whether the page has queried search results. This step 405 can preferably be performed by checking the page's URL against a regular expression of known search results pages. This step 405 can also be accomplished in other ways including, but not limited to, checking the page's structure against a template, checking the Internet Protocol (IP) Address of the provider of the page against those of known search engines, having a proxy Domain Name System (DNS) service provide a list of known search engines, checking the page's metadata for search query information, by asking the user, by requesting information from a third party client, and the like, or by any combination thereof.

If the page has queried search results, the next step 407 is determining whether the page is already stored as the CURRENT reference. In FIG. 4, “last search” is in quotations to denote it is a reference to a last search query results page. Step 407 is preferably performed by checking the page's URL against the URL of the page referenced in the CURRENT reference. This step 407 can also be accomplished in other ways including, but not limited to, comparing the two pages' code or script, comparing the rendering of the two pages, comparing the display of the two pages, interpreting the pages into another format and comparing the interpreted results, comparing the two pages' file names or titles, comparing the two pages' metadata, and the like, or by any combination thereof.

If the page is already stored as the CURRENT reference, then no new action 411 is required because the currently stored references do not need to be changed or overwritten; however, if the page is not already stored as the CURRENT reference, then the next step 413 preferably includes storing the page's URL and DOM in the NEXT reference for the active tab. This step 413 can also be accomplished in other ways including, but not limited to, storing the URL or DOM of the page, storing a rendering of the page, interpreting the page into another format and storing the interpreted result, storing the page's file name, storing a subset of code or script within the page, and the like, or by any combination thereof.

If the page does not contain queried search results, then the next step 409 preferably includes determining whether a URL and DOM are stored in the NEXT reference of the tab. This step 409 can also be accomplished in other ways including, but not limited to, checking a boolean associated with the NEXT reference, checking whether the NEXT reference is undefined or NULL, checking for a URL or DOM in the NEXT reference, checking for a file associated with the NEXT reference, checking for metadata contained within the NEXT reference, and the like, or by any combination thereof.

If the NEXT reference of the tab does not contain the data sought after, such as a URL and DOM, then no new action 417 is required because the currently stored references do not need to be changed or overwritten; however, if the NEXT reference of the tab does contain the data sought after, such as a URL and DOM, then the next step 415 preferably includes storing the URL and DOM of the NEXT reference as that of the CURRENT reference of the tab, and erasing the URL and DOM from the NEXT reference. The step storing the NEXT reference to the CURRENT reference 415 can also be accomplished in other ways including, but not limited to, storing the URL or DOM of the NEXT reference, storing a rendering of the NEXT reference, storing a file name associated with the NEXT reference, storing a subset of code or script associated with the NEXT reference, and the like, or by any combination thereof.

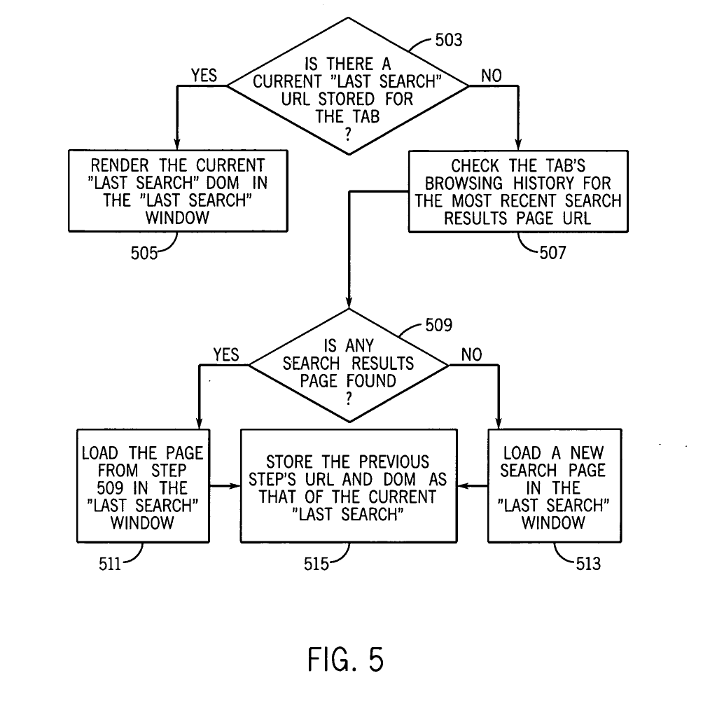

FIG. 5 is a flow chart illustrating an example rendering process according to an embodiment of the present invention. Rendering one page per tab helps free up client resources better than rendering multiple pages that a user may choose to select. Rendering is an independent process that preferably occurs after steps 411, 413, 415 or 417, but otherwise may be triggered periodically, upon an event or upon a user action. The rendering process 501 preferably starts with determining whether there is a URL stored in the CURRENT reference 503. Again, in FIG. 5 “last search” is in quotations to denote it is a reference to a last search query results page. This step 503 can also be accomplished in other ways including, but not limited to, checking a boolean associated with the CURRENT reference, checking whether the CURRENT reference is undefined or NULL, checking for a DOM in the CURRENT reference, checking for a DOM and URL in the CURRENT reference, checking for a file associated with the CURRENT reference, checking for metadata contained within the CURRENT reference, and the like, or by any combination thereof.

If the CURRENT reference of the tab does contain the data sought after, such as a URL, then the next step 505 requires rendering the CURRENT reference DOM in a separate window. Rendering refers to the process of processing and loading a page or graphic so the item can be displayed, but does not refer to displaying the page. This separate window preferably is separate from the window containing the content displayed by the browser, but may include GUIs such as panels, tabs, layers, screens, interfaces, docks, centers, or portions of the screen. In order to promote understanding of the invention, this separate window is referred to simply as the “last search” window.

In contrast to step 505, if the CURRENT reference of the tab does not contain the data sought after, then the next step 507 is to search the browsing history of the tab for the most recent search query results page. This search is preferably done by comparing the tab's browsing history URL's against a regular expression of known search query results page URL's, but this step 507 can also be accomplished in other ways including, but not limited to, checking the page against a list of previously stored search query results pages, checking metadata or header information in the browsing history of the tab, checking a reference that stores the number of pages between the current page and the last search query results page, and the like, or by any combination thereof.

Once completing this action 507, the next step 509 is determining if a search query results page was found. If such a page was found, then the next action 511 includes rendering that search query results page in the “last search” window. In contrast to step 511, if no search query results page is found, then the next action 513 is rendering a search query page in the “last search” window.

After accomplishing rendering step 511 or rendering step 513, the next action 515 is preferably to store the page URL and DOM of whatever page was rendered as that of the CURRENT reference. This step 515 can also be accomplished in other ways including, but not limited to, storing the URL or DOM of the page from rendering steps 513, 511, storing a rendering of the page, interpreting the page into another format and storing the interpreted result, storing the page's file name, storing a subset of code or script within the page, and the like, or by any combination thereof.

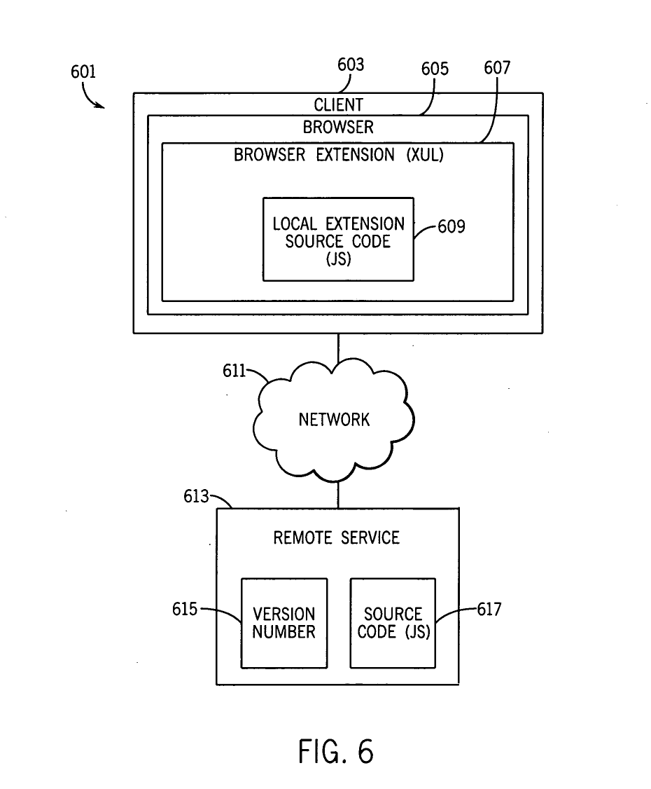

FIG. 6 is a schematic diagram illustrating an example system blueprint for providing a browser extension according to an embodiment of the present invention. The system 601 can include a client 603, a network 611, and a remote service 613. The remote service 613 has files storing the most up-to-date version of browser extension source code 617, preferably in JavaScript, and a version number 615 of the most up-to-date browser extension. The client 603 accesses the remote service 613 through the network 611. The client has a web browser 605, a browser extension 607, preferably in an eXtensible Markup Language (XML) User Interface Language (XUL), and local extension source code 609, preferably in JavaScript. The browser extension 607 is essentially a blank document for the local extension source code 609 to fill in.

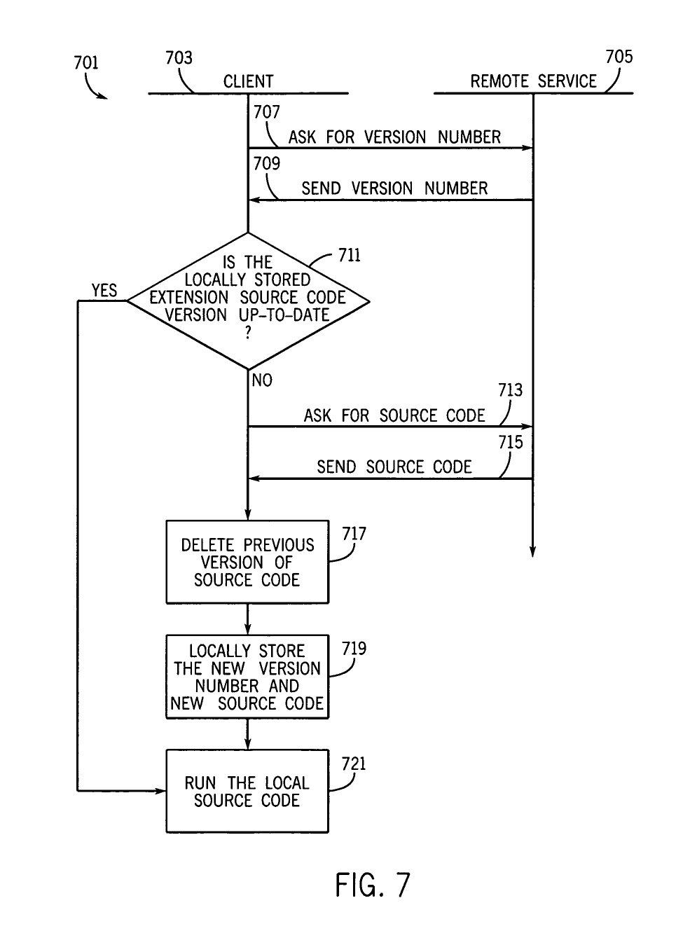

FIG. 7 is a schematic diagram illustrating an example process for providing an extension according to an embodiment of the present invention. The providing process 701 includes a client 703 running and a remote service 705 running concurrently. The client 703 asks the remote service 705 for a version number 707 of the latest version of the extension. The remote service receives the request and sends the client a version number 709 of the latest version of the extension. The client then compares the version number of its locally stored source code with the version number sent from the remote service 711 to determine if the locally stored extension source code is up-to-date.

If the version is up-to-date, then the client runs the local source code 721 as is; if the local source code is not up-to-date, then the client asks the remote service for the latest source code 713, and the remote service responds by sending the source code to the client 715. The client then deletes the old version of its locally stored source code 717, and locally stores the new version of source code with its new version number 719. With the new source code stored locally on the client, the client then runs the new source code as the local source code 721. This process is a convenient method for providing a browser extension because the user need not manually update the source code every time the browser is opened; instead, the extension can automatically be updated by this process. For more user control, additional steps can be added requesting consent from the user before a single step or combination of steps is completed. Optionally, step 715 may include a safeguard to check whether the downloaded file is corrupted.

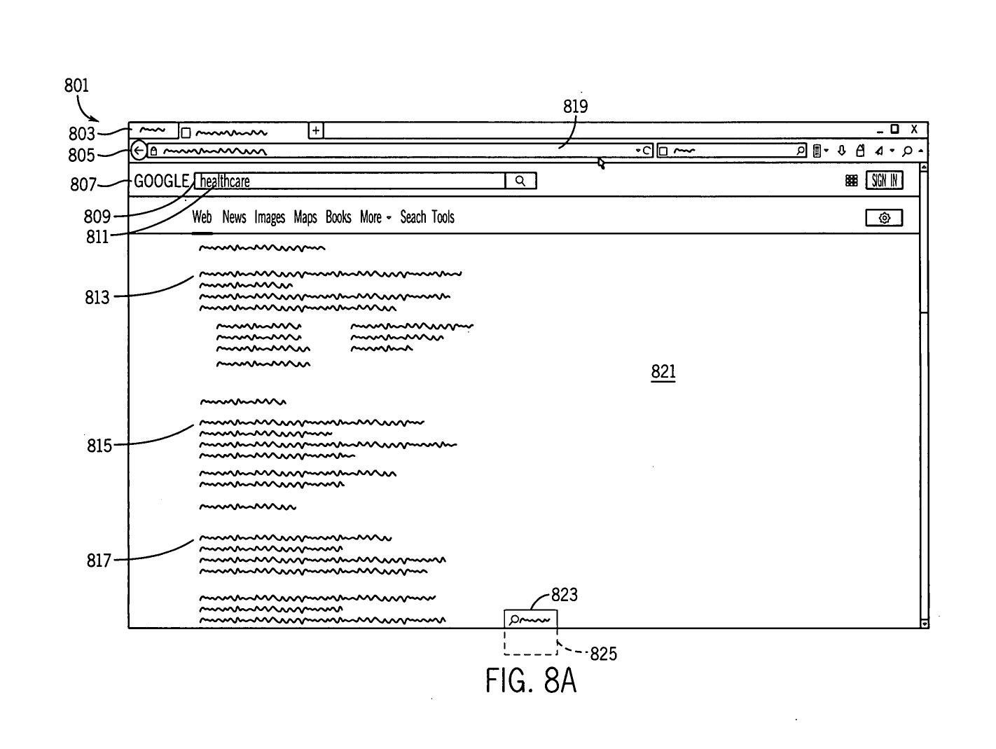

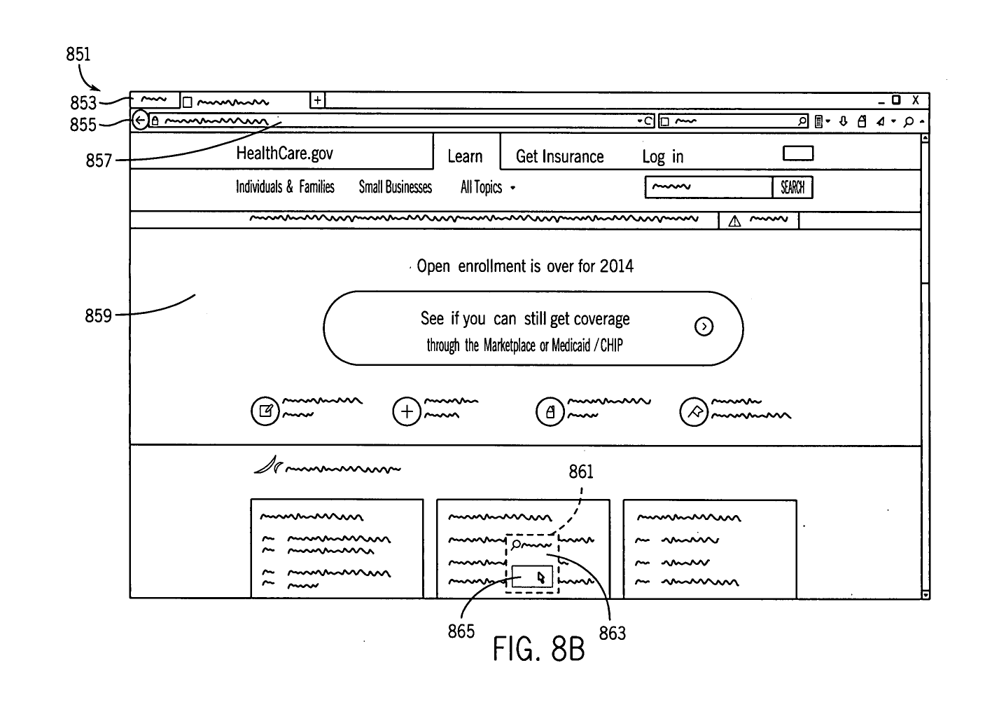

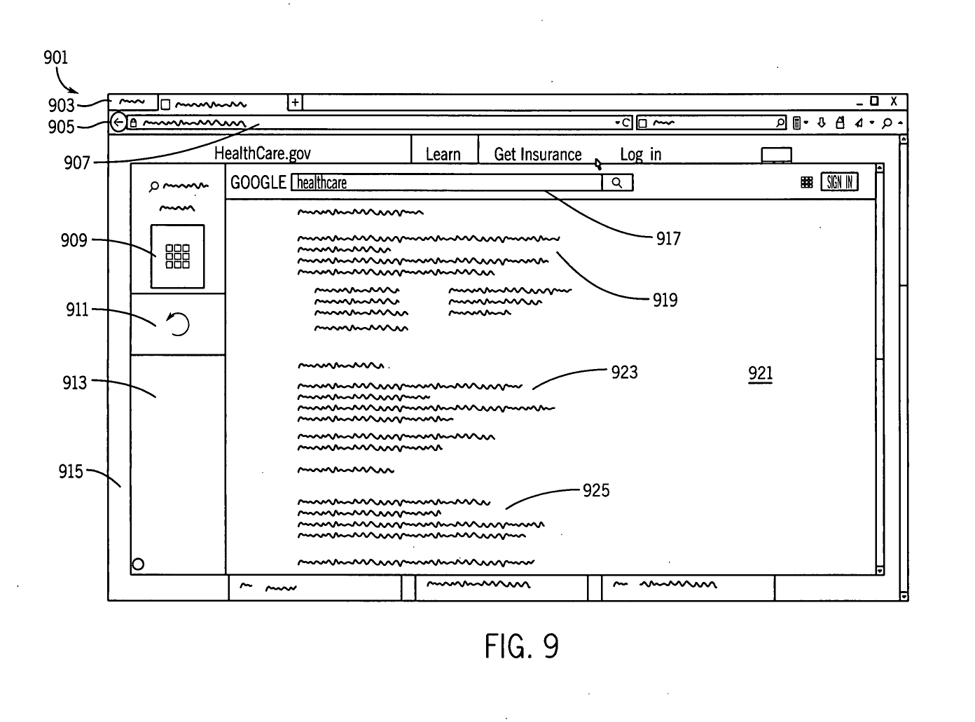

FIGS. 8A, 8B, and 9 illustrate a typical user flow of an embodiment of the invention. Hot-keys and widgets speed up task time associated with web searching by providing an intuitive interface that helps the user without distracting the user from the content on the page.

FIG. 8A is a schematic template illustrating an example Graphical User Interface (GUI) of a browser with an extension according to an embodiment of the present invention. This page is an example of the results of step 203. The template 801 includes a browser 803 on a search query results page 821. The browser can include a back button 805, an address bar 819, and a search bar 809 connected to a search engine provider 807. The example search query here was for “healthcare” 811. The first search result 813 is a link to healthcare.gov (https://www.healthcare.gov/ (accessed 10 Mar. 2015)). The second search result 815 is a categorized search result for “News for healthcare” (http://www.theatlantic.com/health/archive/2014/04/what-american-healthcare-can-learn-from-germany/360133/ (accessed 10 Mar. 2015)). The third search result 817 is a link to a Wikipedia page on healthcare (http://en.wikipedia.org/wiki/Health_care (accessed 10 Mar. 2014)). Access to the last search query results page can be granted through for example an icon 823 that is hidden partially off screen through a window overlay 825. An example of step 205 would be a user selecting on the first search result 813.

FIG. 8B is a schematic template illustrating an example GUI of a browser with an extension after triggering an intermediate event according to an embodiment of the present invention. This page is an embodiment of an intermediate step occurring in step 211. The template 851 includes a browser 853 on a search result page 859. This search result page 859 is the first search result 813 from FIG. 8A. The browser can include a back button 855 and an address bar 857. Here, the window overlay 861 has been pulled up by bringing the cursor 865 over the icon 863 as it was previously (823). Now that the window overlay 861 is fully accessible, the user can easily select the icon 863. An example of step 211 would be a user selecting the icon 863.

FIG. 9 is a schematic template illustrating an example display of a search query results window according to an embodiment of the present invention. This page is an embodiment of step 213. The template 901 includes a browser 903 with a separate window 913 of a search query result page 921 overlaid on a search result page 859. The overlay 915 is on top of the search result page 859 from FIG. 8B. The browser can include a back button 905 and an address bar 907. Here, the separate window 913 has an apps menu button 909, refresh button 911 to re-run the search query, and a search bar 917. The first search result 919, the second search result 923, and third search result 925 correspond to the first, second, and third search results in FIG. 8A 813, 815, 817 respectively. An example of step 215 would be a user selecting the first search result 919 which would send the user back to FIG. 8A.

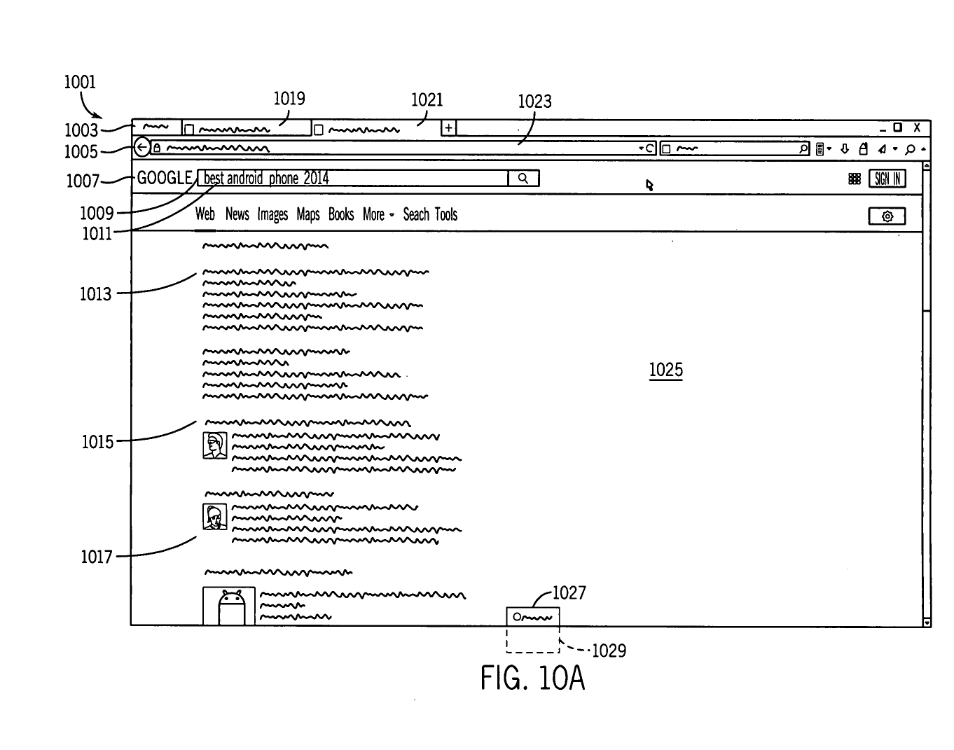

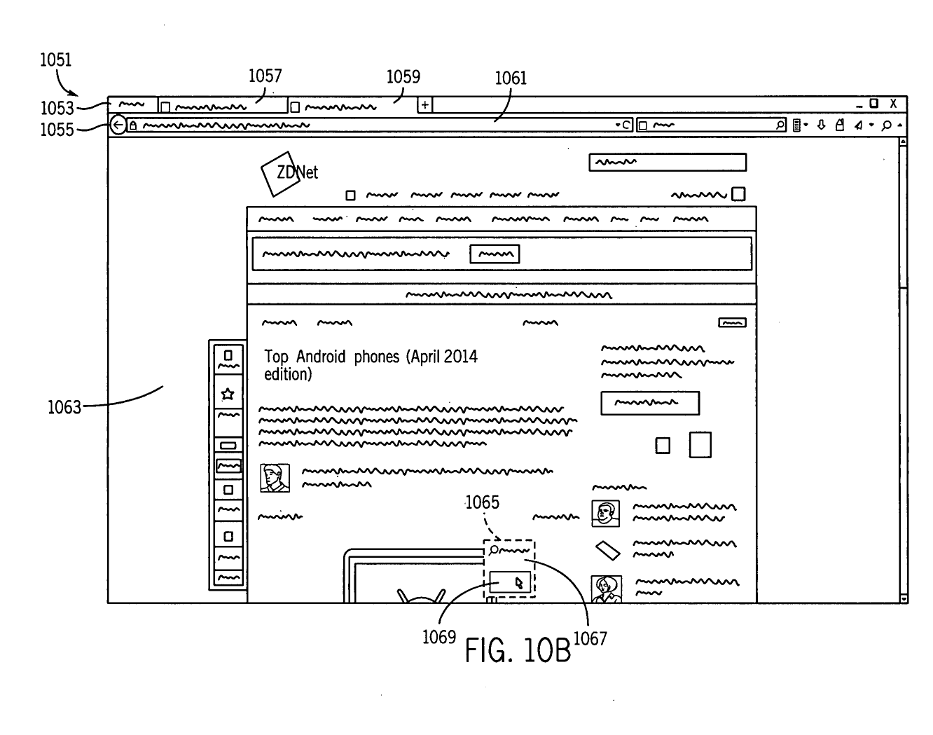

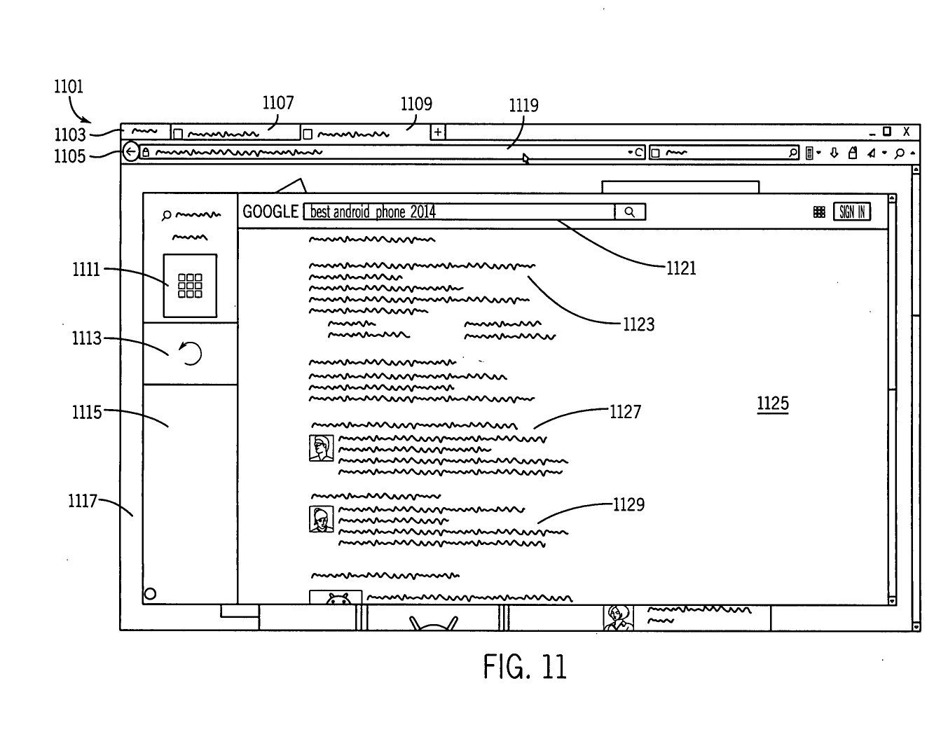

FIGS. 10A, 10B, and 11 illustrate a typical user flow of an embodiment of the invention using tabs as a method of organizing web searching to reduce overall task time. Saving last search data for each tab organizes searching more effectively than conglomerating all searches on one page.

FIG. 10A is a schematic template illustrating an example GUI of a browser with an active tab according to an embodiment of the present invention. This page is an embodiment of the results of transition 305. Two tabs are open in the browser 1003: an active tab 1021 and an inactive tab 1019. The template 1001 includes a browser 1003 on a search query results page 1025. The browser can include a back button 1005, an address bar 1023, and a search bar 1009 connected to a search engine provider 1007. The search query here is for “best android phone” 1011 and the list of result were given. The first search result 1013 is a link to an advertisement for the HTC One (http://vipcares.com/di/dwcf-designed-for-those-who-demand-more-buy-now/(accessed 10 Mar. 2015)). The second search result 1015 is a link to a website about top Android phones (http://www.zdnet.com/pictures/top-android-phones-april-2014-edition/(accessed 10 Mar. 2015)). The third search result 1017 is a link to a webpage about best Android phones http://gadgetadvices.ga/best-android-phones-2014-t3-t3-latest-tech-news/(accessed 10 Mar. 2015)). Access to the last search results for this active tab 1021 is granted through for example an icon 1027 that is hidden partially off screen through a window overlay 1029. An example of transition 309 would be a user selecting the second search result 1015.

FIG. 10B is a schematic template illustrating an example GUI of a browser with an active tab after triggering an intermediate event according to an embodiment of the present invention. This page is an embodiment of an intermediate step in step 211. Two tabs are open in the browser 1053: an active tab 1059 and an inactive tab 1057. The template 1051 includes a browser 1053 on a search result page 1063. This search result page 1063 is the second search result 1015 from FIG. 10A. The browser can include a back button 1055 and an address bar 1061. Here, the window overlay 1065 has been pulled up by bringing the cursor 1069 over the icon 1067 as it was previously (1027). Now that the window overlay 1065 is fully accessible, the user can easily select the icon 1067. An example of step 211 would be a user selecting the icon 1067.

FIG. 11 is a schematic template illustrating an example display of a search query results window for an active tab according to an embodiment of the present invention. This page is an embodiment of step 213. Two tabs are open in the browser 1103: an active tab 1109 and an inactive tab 1107. The template 1101 includes a browser 1103 with a separate window 1115 of a search query result page 1125 overlaid on a search result page 1063. The overlay 1117 is on top of the search result page 1063 from FIG. 10B. The browser has a back button 1105 and an address bar 1119. Here, the separate window 1115 has an apps menu button 1111, refresh button 1113 to re-run the search query, and a search bar 1121. The first search result 1123, the second search result 1127, and third search result 1129 correspond to the first, second, and third search results in FIG. 10A 1013, 1015, 1017 respectively. An example of step 215 would be a user selecting the second search result 1127 which would send the user back to FIG. 10A.

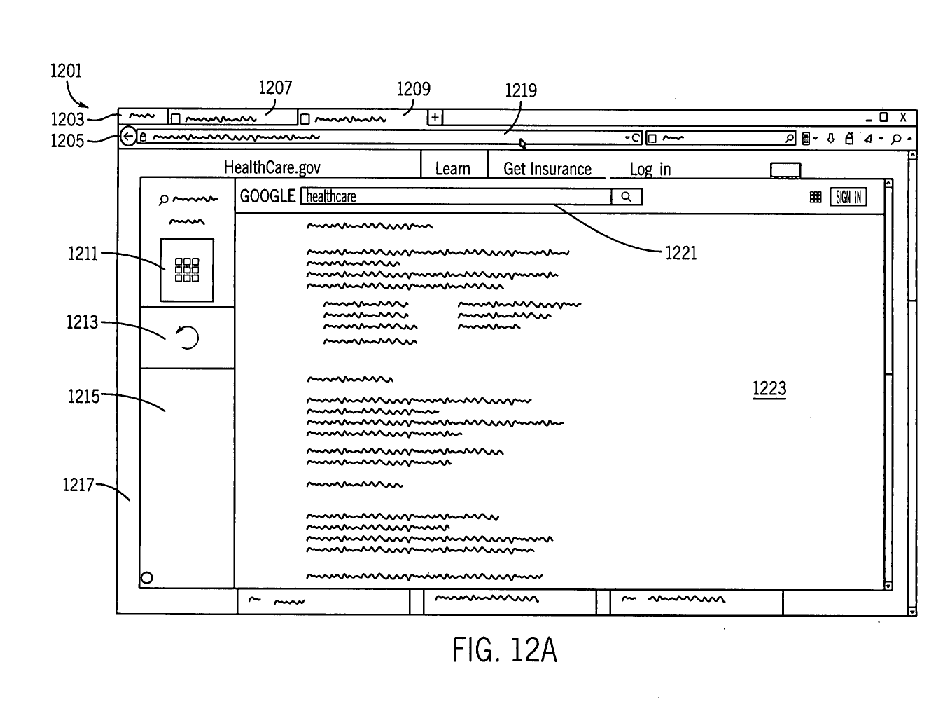

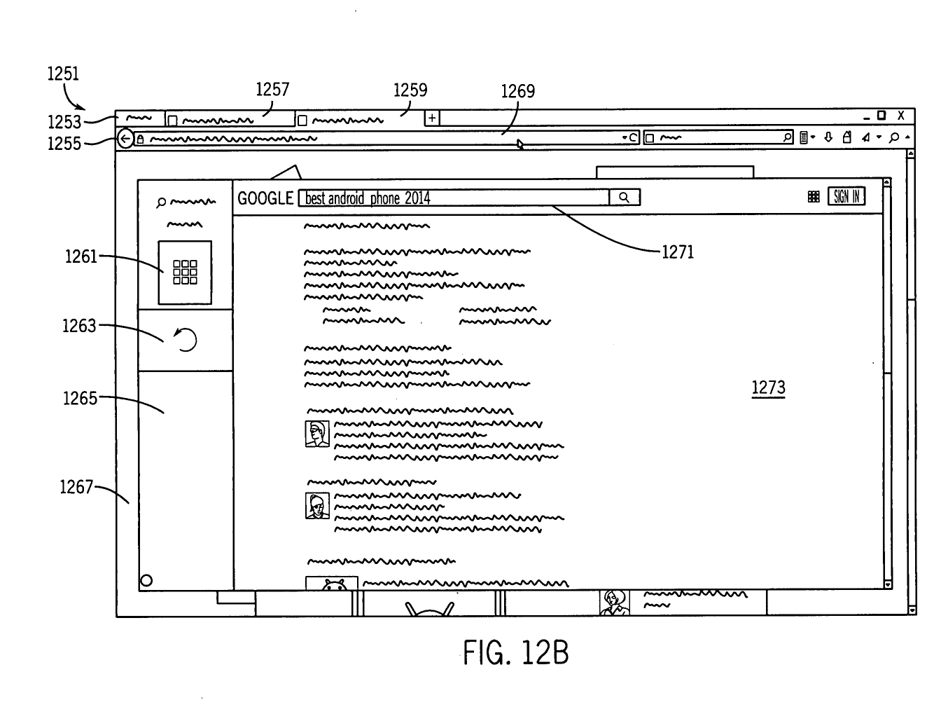

FIGS. 12A and 12B provide a comparison of an embodiment of the invention using the back button history of different tabs as a method of obtaining the last search result of a tab to reduce overall task time of web searching. Automatically, searching through the URLs associated with different back buttons for the last search results is a novel advancement in web navigation.

FIG. 12A is a schematic template illustrating an example GUI of a browser with a search results window for a first active tab according to an embodiment of the present invention. This page is an embodiment of step 213. Two tabs are open in the browser 1203: a first active tab 1207 and a second inactive tab 1209. The template 1201 includes a browser 1203 with an overlay 1217 of a separate window 1215 of a search query result page 1223 on a search result page. The browser can include a back button 1205 and an address bar 1219. Here, the separate window 1215 has an apps menu button 1211, refresh button 1213 to re-run the search query, and a search bar 1221. This search query results page 1223 is pulled from the back button history 1205 of the first active tab 1207.

FIG. 12B is a schematic template illustrating an example GUI of a browser with a search results window for a second active tab according to an embodiment of the present invention. This page is an embodiment of step 213. Two tabs are open in the browser 1253: a first inactive tab 1257 and a second active tab 1259. The template 1251 includes a browser 1253 with an overlay 1267 of a separate window 1265 of a search query result page 1273 on a search result page. The browser can include a back button 1255 and an address bar 1269. Here, the separate window 1265 has an apps menu button 1261, refresh button 1263 to re-run the search query, and a search bar 1271. This search query results page 1273 is pulled from the back button history 1255 of the second active tab 1259.

While this specification contains many specifics, these should not be construed as limitations on the scope of what may be claimed, but rather as descriptions of particular implementations of the subject matter. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the techniques described herein should not be understood as requiring such separation in all aspects, and it should be understood that the described program components and systems can generally be integrated together in a single software product or packaged into multiple software products.

Although the subject matter has been described with a specific implementation, other alternatives, modifications, and variations will be apparent to those skilled in the art. Accordingly, the disclosure is intended to be illustrative, but not limiting, and such alternatives, modifications, and variations are within the spirit and scope of the following claims.

What is claimed is:

1. A computer implemented method for obtaining information comprising:
creating and storing in a memory a reference of a search query, wherein the reference is stored locally instead of remotely;
automatically with a browser in communication with the memory designating the reference of a last search query;
the browser rendering the designated reference without displaying it to a user; and
displaying the rendered designated reference on a display in communication with the browser upon an event, such that the user may quickly and directly access the last search query.

2. The computer method of claim 1, wherein automatically designating the reference comprises searching data associated with a back button provided in the browser.

3. The computer method of claim 2, wherein the reference to a last returned search query is associated with a tab in the browser.

4. The computer method of claim 3, wherein only one reference is created per tab.

5. The computer method of claim 4, wherein the event only triggers displaying the designated reference within an active tab.

6. The method of claim 4, wherein designating the reference comprises automatically searching only the associated tab's browsing history.

7. The method of claim 4, wherein browsing within the tab does not affect the rendered designated reference unless the user leaves a page from a different returned search query made within the tab.

8. The computer method of claim 4, further comprising a step of designating a hot-key to point to the designated reference within an active tab

9. The computer method of claim 1, wherein the steps of designating and rendering are repeated after each new search query.

10. The computer method of claim 1, wherein the processor is selected from a group consisting of one processor, more than one processor, multiple processors, and combinations thereof.

11. The computer method of claim 1, wherein the browser is selected from a group consisting of one browser, more than one browser, multiple browsers, and combinations thereof.

12. The computer method of claim 1, wherein the display is selected from a group consisting of one display, more than one display, multiple displays, and combinations thereof.

13. A browser method comprising:
under the control of a client device with a browser, identifying whether a user makes a search query;
locally storing in a memory of a browser or a browser extension a search query results page in a first variable;
storing in the memory the information from the first variable into a second variable only if the user leaves the search query results page; and
providing user access in a display in communication with the browser to the information associated with the second variable for leaping back to the last query results page while the user navigates through other pages.

14. The method of claim 13, wherein the user is provided access through a displayed widget.

15. The method of claim 13, wherein information in the second variable comprises metadata associated with the search query results, a search query results page URL, and a DOM comprising HTML from the search query results page.

16. The method of claim 15, wherein the document object model has two or more search query results rendered in a list.

17. The method of claim 15, wherein the first and second variables are created only for the duration of the browsing session.

18. The computer method of claim 13, wherein the browser extension is selected from a group consisting of one browser extension, more than one browser extension, multiple browser extensions, and combinations thereof.

19. A computer method comprising the steps of:
providing in a browser extension a memory for storing a search query results page for an active tab opened in a browser;
in response to entering a new tab, locally storing data associated with the search query results page in the browser extension;
in response to leaving the search query results page, storing the data associated with the search query results page in the browser extension; and
rendering at least some of the data associated with the search query results page in a separate window.

20. The computer method of claim 19, further comprising displaying the separate window upon at least two events.

21. The computer method of claim 20, wherein at least one event is a mouse-over event.

22. The computer method of claim 19, wherein the browser extension includes a GUI for hiding and accessing the separate window.

23. The computer method of claim 19, wherein the browser extension renders a search page if no last returned query results page has been stored.

24. The computer method of claim 19, further comprising the step of upon launching a browser on a client device, automatically comparing a former version of the browser extension with a current version of the browser extension, wherein a remote service provides a current version of the browser extension only when the former version of the browser extension is locally stored and the current version is stored on the remote service.
